(19) United States
(12) Patent Application Publication
(10) Pub. No.: US 2025/0104908 A1
(43) Pub. Date: Mar. 27, 2025

(54) WOUND CORE PRODUCING APPARATUS AND WOUND CORE PRODUCING METHOD

(71) Applicant: NIPPON STEEL CORPORATION, Tokyo (JP)

(72) Inventors: Takahito MIZUMURA, Tokyo (JP); Hisashi MOGI, Tokyo (JP)

(73) Assignee: NIPPON STEEL CORPORATION, Tokyo (JP)

(21) Appl. No.: 18/832,818

(22) PCT Filed: Feb. 2, 2023
(86) PCT No.: PCT/JP2023/003468

§ 371 Date: Jul. 24, 2024

(30) Foreign Application Priority Data
Feb. 4, 2022 (JP) 2022-016397

(51) Int. Cl. H01F 41/02

(52) U.S. Cl. CPC H01F 41/024

(57) ABSTRACT

This wound core producing apparatus (40) includes a bending device (20) that bends a steel sheet (21), and a feed roll (60) that feeds the steel sheet (21) to the bending device (20), in which the bending device (20) includes a die (22) and a punch (24), the die (22) includes a curved portion (51) disposed at an end portion on the punch (24) side, and a flat portion (52) continuously connected to the curved portion (51) from a direction opposite to the punch (24) side and in contact with the steel sheet (21), and when a distance from a center of the feed roll (60) to an end surface on the die (22) side of the punch (24) along a conveyance direction (25) of the steel sheet (21) is denoted by L mm, a diameter of the feed roll (60) is denoted by R mm, a pressure applied to the steel sheet (21) by the feed roll (60) is denoted by p MPa, and a temperature at a position 20 mm away from a boundary between the curved portion (51) and the flat portion (52) in a direction opposite to the conveyance direction (25) is denoted by T° C., predetermined formulas are satisfied.

### TECHNICAL FIELD OF THE INVENTION

The present invention relates to a wound core producing apparatus and a wound core producing method.

The present application claims priority based on Japanese Patent Application No. 2022-016397 filed in Japan on Feb. 4, 2022, the contents of which are incorporated herein by reference.

### RELATED ART

A wound core is widely used as a magnetic core for a transformer, a reactor, a noise filter, or the like. Conventionally, reduction of iron loss occurring in a core has been an important problem from the viewpoint of high efficiency and the like, and reduction of iron loss has been studied from various viewpoints.

For example, Patent Document 1 discloses the following wound core producing method. In this producing method, a coated grain-oriented electrical steel sheet having a coating containing phosphorus on a surface is bent into a bent body, and a plurality of bent bodies are laminated in a sheet thickness direction to produce a wound core. When bending the coated grain-oriented electrical steel sheet, the bending is performed in a state in which a portion to be a bent region of the bent body is set to 150° C. or higher and 500° C. or lower. The plurality of obtained bent bodies are laminated in the sheet thickness direction. According to such a method, the number of deformation twins in the bent region of the bent body is suppressed, and a wound core in which iron loss is suppressed is obtained.

For example, in the method of Patent Document 2, the following wound core producing method is disclosed. In this producing method, a coated grain-oriented electrical steel sheet is prepared, and the coated grain-oriented electrical steel sheet is formed into the bent body. In the bending, the coated grain-oriented electrical steel sheet is bent under the condition that a portion to be the bent region of the bent body is heated to 45° C. or higher and 500° C. or lower and an absolute value of a local temperature gradient at an arbitrary position in a longitudinal direction of the coated grain-oriented electrical steel sheet is less than 400° C./mm in a flat region in the strain influence region to form the bent body. The plurality of bent bodies is laminated in a sheet thickness direction. According to such a method, the number of deformation twins in the bent region is suppressed, and a wound core in which iron loss is suppressed is obtained.

### CITATION LIST

### Patent Document

### Patent Document 1

PCT International Publication No. WO 2018/131613

### Patent Document 2

PCT International Publication No. WO 2020/218607

### SUMMARY OF INVENTION

### Problems to be Solved by the Invention

However, in the wound core producing apparatuses disclosed in Patent Documents 1 and 2, although about 1 to 2 wound cores can be produced, there is a possibility that a wound core in which iron loss is suppressed cannot be continuously produced.

The present invention has been made in view of the above problem and provides a wound core producing apparatus and a wound core producing method capable of stably producing a wound core in which iron loss is suppressed.

### Means for Solving the Problem

In order to solve the above problem, the present invention proposes the means described below.

<1> A wound core producing apparatus according to Aspect 1 of the present invention is a wound core producing apparatus, the wound core being formed by bending and laminating a steel sheet, the wound core producing apparatus including:
a bending device that bends the steel sheet; and
a feed roll that feeds the steel sheet to the bending device,
in which
the bending device includes a die and a punch for press working,
the punch is shifted in a conveyance direction of the steel sheet with respect to the die,
the die includes a curved portion disposed at an end portion on the punch side, and a flat portion continuously connected to the curved portion from a direction opposite to the punch side and in contact with the steel sheet, and
when a distance from a center of the feed roll to an end surface on the die side of the punch along the conveyance direction of the steel sheet is denoted by L mm, a diameter of the feed roll is denoted by R mm, a pressure applied to the steel sheet by the feed roll is denoted by p MPa, and the temperature at a position 20 mm away from a boundary between the curved portion and the flat portion in a direction opposite to the conveyance direction is denoted by T° C., the following formulas (1) and (2) are satisfied.

$$0.12 \leq ( L \times p ) / ( T \times R ) \leq 0 \text{.40} \qquad ( 1 )$$

$$0.4 \leq p \leq 2.00 \qquad ( 2 )$$

<2> According to Aspect 2 of the present invention, in the wound core producing apparatus according to Aspect 1, a material of the feed roll may be rubber, and the Shore hardness of the rubber measured at 45° C. may be A37 or less.

<3> According to Aspect 3 of the present invention, in the wound core producing apparatus according to Aspect 2, a material of the feed roll may be urethane rubber.

<4> In a wound core producing method according to Aspect 4 of the present invention, a wound core is produced using the wound core producing apparatus according to any one of Aspects 1 to 3.

### Effects of the Invention

According to the above aspects of the present invention, it is possible to provide a wound core producing apparatus and a wound core producing method capable of stably producing a wound core in which iron loss is suppressed even when the wound core is produced.

### BRIEF DESCRIPTION OF THE DRAWINGS

FIG. 1 is a perspective view illustrating a wound core according to a first aspect.

FIG. 2 is a side view of the wound core in FIG. 1.

FIG. 3 is a side view illustrating a wound core according to a second aspect.

FIG. 4 is a side view illustrating a wound core according to a third aspect.

FIG. 5 is an enlarged side view of the vicinity of a corner portion of the wound core in FIG. 1,

FIG. 6 is an enlarged side view of an example of a bent region.

FIG. 7 is a side view of a bent body of the wound core in FIG. 1.

FIG. 8 is an explanatory view illustrating a first example of a wound core producing apparatus used in a wound core producing method.

FIG. 9 is a schematic view illustrating dimensions of a wound core produced at the time of characteristic evaluation.

### EMBODIMENTS OF THE INVENTION

### (Wound Core)

First, a wound core produced by a wound core producing apparatus according to an embodiment of the present invention will be described in detail. However, the present invention is not limited only to the configuration disclosed in the present embodiment, and various modifications can be made without departing from the gist of the present invention. Note that a numerical range described below includes the lower limit and the upper limit. A numerical value indicated as “more than” or “less than” is not included in the numerical range. In addition, unless otherwise specified, the unit “%” regarding the chemical composition means “mass %”.

Terms such as “parallel”, “perpendicular”, “identical”, and “at right angle”, values of length and angle, and the like, which specify shapes, geometric conditions, and degrees thereof, used in the present specification are not to be bound by a strict meaning but are to be interpreted including a range in which similar functions can be expected.

In the present disclosure, substantially 90° allows an error of +3°, and means a range of 87° to 93°.

A wound core according to the present disclosure is a wound core formed by laminating, in a sheet thickness direction, a plurality of bent bodies formed from a coated grain-oriented electrical steel sheet, in which a coating is formed on at least one surface of the grain-oriented electrical steel sheet, such that the coating is on an outer side, in which the bent body has a bent region obtained by bending the coated grain-oriented electrical steel sheet, and a flat region adjacent to the bent region.

### “Coated Grain-Oriented Electrical Steel Sheet”

The coated grain-oriented electrical steel sheet in the present disclosure includes at least a grain-oriented electrical steel sheet (sometimes referred to as a “base steel sheet” in the present disclosure) and a coating formed on at least one surface of the base steel sheet. The coated grain-oriented electrical steel sheet has at least a primary coating as the coating and may further have another layer as necessary. Examples of the other layer include a secondary coating provided on the primary coating.

Hereinafter, the configuration of the coated grain-oriented electrical steel sheet will be described.

### <Grain-Oriented Electrical Steel Sheet>

In the coated grain-oriented electrical steel sheet constituting the wound core 10 according to the present disclosure, the base steel sheet is a steel sheet in which the orientation of grains is highly accumulated in a {110}<001> orientation. The base steel sheet has exceptional magnetic properties in a rolling direction.

The base steel sheet used for the wound core according to the present disclosure is not particularly limited. As the base steel sheet, a known grain-oriented electrical steel sheet can be appropriately selected and used. Hereinafter, an example of a preferable base steel sheet will be described, but the base steel sheet is not limited to the following example.

The chemical composition of the base steel sheet is not particularly limited, but for example, it is preferable that the base steel sheet contains, in mass %, Si: 0.8% to 7%, C: more than 0% and 0.085% or less, acid-soluble Al: 0% to 0.065%, N: 0% to 0.012%, Mn: 0% to 1%, Cr: 0% to 0.3%, Cu: 0% to 0.4%, P: 0% to 0.5%, Sn: 0% to 0.3%, Sb: 0% to 0.3%, Ni: 0% to 1%, S: 0% to 0.015%, and Se: 0% to 0.015%, and the remainder is Fe and impurity elements.

The above chemical composition of the base steel sheet is a preferred chemical component for controlling the crystal orientation to a Goss texture accumulated in the {110}<001> orientation.

Among the elements in the base steel sheet, Si and Care basic elements (essential elements) except Fe, and acid-soluble Al, N, Mn, Cr, Cu, P, Sn, Sb, Ni, S, and Se are selected elements (optional elements). Since these selected elements may be contained depending on the object, it is not necessary to limit the lower limit, and these selected elements may not be substantially contained. In addition, even if these selected elements are contained as impurity elements, the effects of the present disclosure are not impaired. The base steel sheet contains Fe and impurity elements as the remainder of the basic elements and the selected elements.

However, when the Si content of the base steel sheet is 2.0% or more in mass %, classical eddy-current loss of the product is suppressed, which is preferable. The Si content of the base steel sheet is more preferably 3.0% or more. In addition, when the Si content of the base steel sheet is 5.0% or less in mass %, fracture of the steel sheet is less likely to occur in a hot rolling step and cold rolling, which is preferable. The Si content of the base steel sheet is more preferably 4.5% or less.

The “impurity element” means an element unintentionally mixed from ore as a raw material, scrap, a producing environment, or the like when the base steel sheet is industrially produced.

In addition, the grain-oriented electrical steel sheet generally undergoes purification annealing during secondary recrystallization. In the purification annealing, an inhibitor-forming element is discharged to the outside of the system. Particularly, for N and S, the concentration remarkably decreases to 50 ppm or less. Under normal purification annealing conditions, the concentration reaches 9 ppm or less, further 6 ppm or less, and a degree that cannot be detected by general analysis (1 ppm or less) if purification annealing is sufficiently performed.

The chemical component of the base steel sheet may be measured by a general analysis method of steel. For example, the chemical component of the base steel sheet may be measured by inductively coupled plasma-atomic emission spectrometry (ICP-AES). Specifically, for example, the chemical component can be specified by acquiring a test piece of 35 mm square from a center position in a width direction of the base steel sheet after removal of a coating, and performing measurement under a condition based on a calibration curve created in advance using ICPS-8100 produced by Shimadzu Corporation or the like (measurement apparatus). C and S may be measured by a combustion-infrared absorption method, and N may be measured by an inert gas fusion-thermal conductivity method.

The chemical component of the base steel sheet is a component obtained by analyzing a component of a steel sheet obtained by removing a glass coating, a coating containing phosphorus, and the like described later from a grain-oriented electrical steel sheet by a method described later as the base steel sheet.

### <Primary Coating>

The primary coating is a coating directly formed on a surface of a grain-oriented electrical steel sheet as a base steel sheet without any other layer or film, and examples thereof include a glass coating. Examples of the glass coating include a coating having one or more oxides selected from forsterite (Mg₂SiO₄), spinel (MgAl₂O₄), and cordierite (Mg₂Al₄Si₅O₁₆).

The method for forming the glass coating is not particularly limited, and can be appropriately selected from known methods. For example, a specific example of a method for producing the base steel sheet includes a method in which an annealing separator containing one or more selected from magnesia (MgO) and alumina (Al₂O₃) is applied to a cold-rolled steel sheet, and then finish annealing is performed. The annealing separator also has an effect of suppressing sticking of steel sheets during finish annealing. For example, when finish annealing is performed by applying the annealing separator containing magnesia, silica contained in the base steel sheet reacts with the annealing separator to form a glass coating containing forsterite (Mg₂SiO₄) on a base steel sheet surface.

For example, a coating containing phosphorus described later may be formed as a primary coating without forming a glass film on a surface of a grain-oriented electrical steel sheet.

The thickness of the primary coating is not particularly limited, but is preferably, for example, 0.5 μm or more and 3 μm or less from the viewpoint of forming the primary coating on the entire surface of a base steel sheet and suppressing peeling.

### <Other Coatings>

The coated grain-oriented electrical steel sheet may include a coating other than the primary coating. For example, it is preferable that the coated grain-oriented electrical steel sheet have a coating containing phosphorus as a secondary coating on the primary coating mainly for imparting insulation properties. The coating containing phosphorus is a coating formed on the outermost surface of the grain-oriented electrical steel sheet, and when the grain-oriented electrical steel sheet has a glass coating or an oxide coating as a primary coating, the coating containing phosphorus is formed on the primary coating. By forming a coating containing phosphorus on the glass coating formed as a primary coating film on the surface of the base steel sheet, high adhesion can be secured.

The coating containing phosphorus can be appropriately selected from conventionally known coatings. The coating containing phosphorus is preferably a phosphate-based coating, and particularly preferably a coating containing one or more of aluminum phosphate and magnesium phosphate as main components, and further containing one or more of chromium and silicon oxide as accessory components. According to the phosphate-based coating, insulation properties of the steel sheet are secured, and tension is imparted to the steel sheet to be exceptional in reduction of iron loss.

The thickness of the coating containing phosphorus is not particularly limited but is preferably 0.5 μm or more and 3 μm or less from the viewpoint of securing insulation properties.

### <Sheet Thickness>

The sheet thickness of the coated grain-oriented electrical steel sheet is not particularly limited, and may be appropriately selected according to the application and the like but is usually in the range of 0.10 mm to 0.50 mm, preferably 0.13 mm to 0.35 mm, and more preferably in the range of 0.15 mm to 0.30 mm.

### (Configuration of Wound Core)

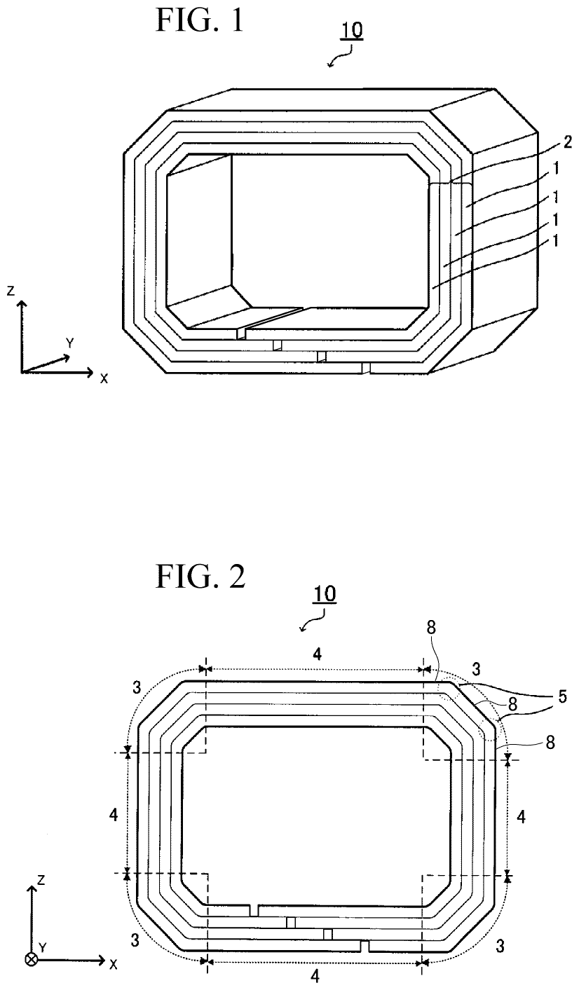

An example of a configuration of a wound core according to the present disclosure will be described with reference to a wound core 10 in FIGS. 1 and 2 as an example. FIG. 1 is a perspective view of a wound core 10, and FIG. 2 is a side view of the wound core 10 in FIG. 1.

In the present disclosure, viewing from the side means viewing in a width direction (Y-axis direction in FIG. 1) of a coated grain-oriented electrical steel sheet in a long shape constituting a wound core. The side view is a view illustrating a shape visually recognized by viewing from the side (a view in the Y-axis direction in FIG. 1). The sheet thickness direction is a sheet thickness direction of a coated grain-oriented electrical steel sheet and means a direction perpendicular to a circumferential surface of a wound core in a state of being formed into a rectangular wound core. Here, the direction perpendicular to a circumferential surface means a direction perpendicular to the circumferential surface when the circumferential surface is viewed from the side. When the circumferential surface forms a curve in viewing the circumferential surface from the side, the direction perpendicular to the circumferential surface (sheet thickness direction) means a direction perpendicular to a tangent of the curve formed by the circumferential surface.

The wound core 10 is configured by laminating a plurality of bent bodies 1 in a sheet thickness direction thereof. That is, as illustrated in FIGS. 1 and 2, the wound core 10 has a substantially rectangular laminated structure including a plurality of bent bodies 1. The wound core 10 may be used as it is as a wound core. If necessary, the wound core 10 may be fixed using a fastening tool such as a known binding band. The bent body 1 is formed from a coated grain-oriented electrical steel sheet, in which a coating is formed on at least one surface of the grain-oriented electrical steel sheet as a base steel sheet.

As illustrated in FIGS. 1 and 2, each of the bent bodies 1 is formed in a rectangular shape by alternately continuing four flat portions 4 and four corner portions 3 along a circumferential direction. An angle formed by two flat portions 4 adjacent to each corner portion 3 is substantially 90°. Here, the circumferential direction means a direction around an axis of the wound core 10.

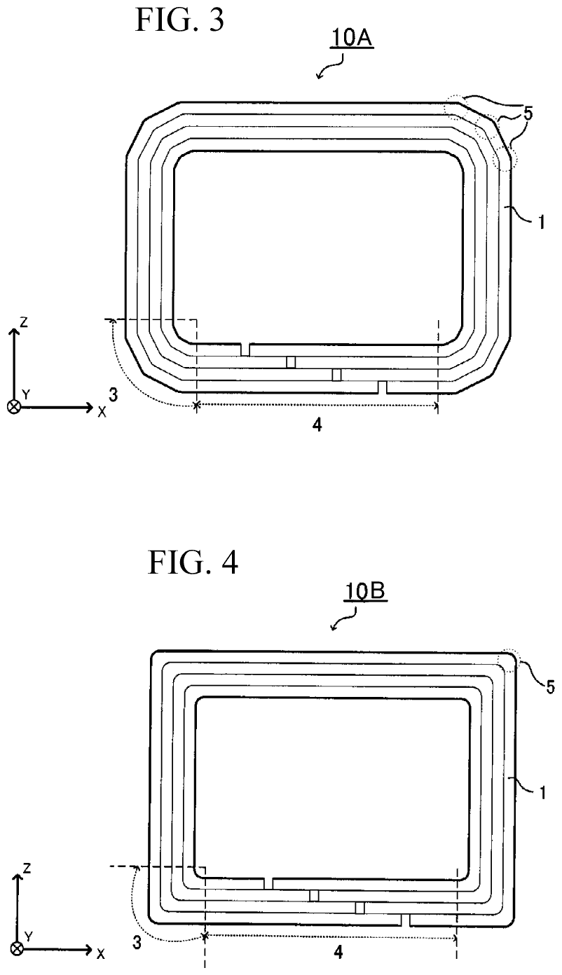

As illustrated in FIG. 2, in the wound core 10, each of the corner portions 3 of the bent body 1 has two bent regions 5. The bent region 5 is a region having a curved bent shape in viewing the bent body 1 from the side, and a more specific definition thereof will be described later. As will also be described later, in the two bent regions 5, bent angles in total are substantially 90° in viewing the bent body 1 from the side. Each of the corner portions 3 of the bent body 1 may have three bent regions 5 in one corner portion 3 as in a wound core 10A according to a second aspect of the present disclosure illustrated in FIG. 3. Further, as in a wound core 10B according to a third aspect illustrated in FIG. 4, one corner portion 3 may have one bent region 5. That is, each of the corner portions 3 of the bent body 1 may have one or more bent regions 5 so that the steel sheet is bent by substantially 90°.

As illustrated in FIG. 2, the bent body 1 has a flat region 8 adjacent to a bent region 5. As the flat region 8 adjacent to a bent region 5, there are two flat regions 8 shown in (1) and (2) below.
(1) A flat region 8 positioned between a bent region 5 and a bent region 5 (between two bent regions 5 adjacent in the circumferential direction) in one corner portion 3 and adjacent to each bent region 5.
(2) A flat region 8 adjacent to each bent region 5 as a flat portion 4.

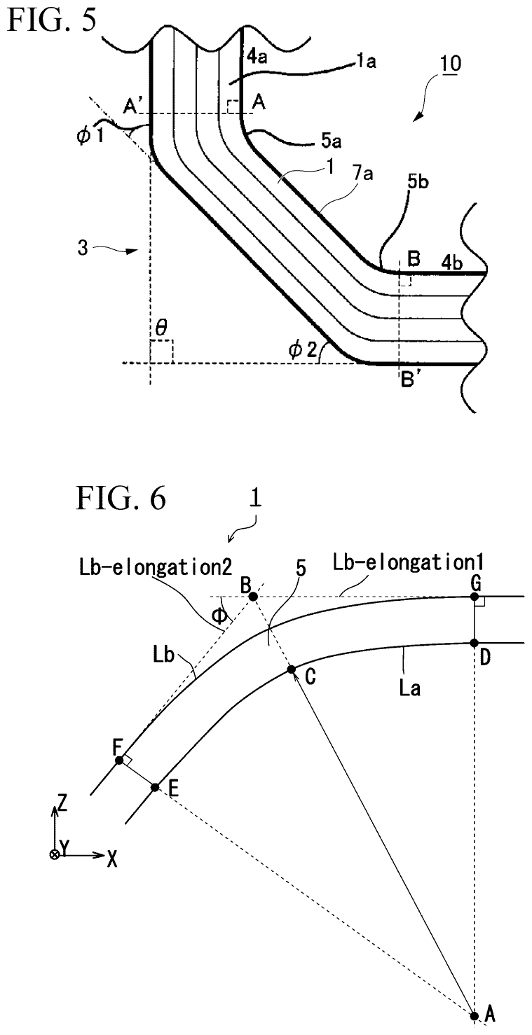

FIG. 5 is an enlarged side view of the vicinity of a corner portion 3 in the wound core 10 in FIG. 1.

As illustrated in FIG. 5, when one corner portion 3 has two bent regions 5a and 5b, a bent region 5a (curved portion) is continuous from a flat portion 4a (straight portion) which is a flat region of the bent body 1, and further, a flat region 7a (straight portion), a bent region 5b (curved portion), and a flat portion 4b (straight portion) which is a flat region are continuous therebeyond.

In the wound core 10, a region from a line segment A-A′ to a line segment B-B′ in FIG. 5 is the corner portion 3. A point A is an end point on a flat portion 4a side in the bent region Sa of the bent body 1a disposed on the innermost side of the wound core 10. A point A′ is an intersection point of a straight line passing through the point A and perpendicular (sheet thickness direction) to a sheet surface of the bent body 1a and the outermost surface of the wound core 10 (an outer circumferential surface of the bent body 1 disposed on the outermost side of the wound core 10). Similarly, a point B is an end point on a flat portion 4b side in the bent region 5b of the bent body 1a disposed on the innermost side of the wound core 10. A point B′ is an intersection point of a straight line passing through the point B and perpendicular (sheet thickness direction) to a sheet surface of the bent body 1a and the outermost surface of the wound core 10. In FIG. 5, an angle formed by two flat portions 4a and 4b adjacent to each other with the corner portion 3 interposed therebetween (angle formed by intersection of extension lines of the flat portions 4a and 4b) is 0, and in the example in FIG. 5, the 0 is substantially 90°. The bent angles of the bent regions 5a and 5b will be described later, but in FIG. 5, the bent angles in total φ1+φ2 of the bent regions 5a and 5b are substantially 90°.

The bent region 5 will be described in more detail with reference to FIG. 6. FIG. 6 is an enlarged side view of an example of the bent region 5 of the bent body 1. The bent angle φ of the bent region 5 means an angular difference generated between a flat region on a rear side in a bending direction and a flat region on a front side in the bending direction in the bent region 5 of the bent body 1. Specifically, the bent angle φ of the bent region 5 is represented as an angle φ of a complementary angle of an angle formed by two imaginary lines Lb-elongation 1 and Lb-elongation 2 obtained by extending straight portions continuous to both sides (points F and G) of a curved portion included in a line Lb representing an outer surface of the bent body 1 in the bent region 5.

The bent angle of each bent region 5 is substantially 90° or less, and the bent angles in total of all the bent regions 5 in one corner portion 3 are substantially 90°.

In viewing the bent body 1 from the side, when points D and E on a line La representing an inner surface of the bent body 1 and the points F and G on the line Lb representing the outer surface of the bent body 1 are defined as follows, the bent region 5 indicates a region surrounded by (1A) a line delimited by the point D and the point E on the line La representing the inner surface of the bent body 1, (2A) a line delimited by the point F and the point G on the line Lb representing the outer surface of the bent body 1, (3A) a straight line connecting the point D and the point G, and (4A) a straight line connecting the point E and the point F.

Here, the point D, the point E, the point F, and the point G are defined as follows.

In viewing from the side, a point at which a straight line AB connecting a center point A of a radius of curvature in a curved portion included in the line La representing the inner surface of the bent body 1 and an intersection point B of the two imaginary lines Lb-elongation 1 and Lb-elongation 2 obtained by extending straight portions adjacent to both sides of the curved portion included in the line Lb representing the outer surface of the bent body 1 intersects the line La representing the inner surface of the bent body 1 is defined as an origin C,
a point separated from the origin C by a distance m represented by the following formula (3) in one direction along the line La representing the inner surface of the bent body 1 is defined as the point D,
a point separated from the origin C by the distance m in another direction along the line La representing the inner surface of the bent body is defined as the point E,
an intersection point between a straight portion facing the point D among the straight portions included in the line Lb representing the outer surface of the bent body and an imaginary line drawn perpendicularly to the straight portion facing the point D and passing through the point D is defined as the point G, and
an intersection point between a straight portion facing the point E among the straight portions included in the line Lb representing the outer surface of the bent body and an imaginary line drawn perpendicularly to the straight portion facing the point E and passing through the point E is defined as the point F. The intersection point A is an intersection point obtained by extending a line segment EF and a line segment DG inward on the opposite side of the point B.

$$m = r \times ( π \times φ / 180 ) \qquad ( 3 )$$

In formula (3), m represents a distance from the origin C, and r represents a distance (radius of curvature) from the center point A to the origin C. The radius of curvature r of the bent body 1 disposed on an inner surface side of the wound core 10 is preferably, for example, 1 mm or more and 5 mm or less.

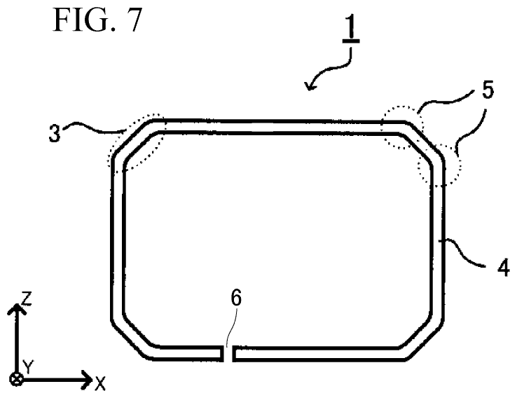

FIG. 7 is a side view of the bent body 1 of the wound core 10 in FIG. 1, As illustrated in FIG. 7, the bent body 1 is obtained by bending a coated grain-oriented electrical steel sheet, and includes four corner portions 3 and four flat portions 4, so that one coated grain-oriented electrical steel sheet forms a substantially rectangular ring in viewing from the side. More specifically, the bent body 1 has a structure in which one flat portion 4 is provided with a gap 6 in which both end surfaces in a longitudinal direction of the coated grain-oriented electrical steel sheet face each other, and the other three flat portions 4 do not include the gap 6.

However, the wound core 10 may have a laminated structure having a substantially rectangular shape as a whole in viewing from the side. The wound core 10 may have a configuration in which two flat portions 4 include the gap 6 and the other two flat portions 4 do not include the gap 6. In this case, a bent body is formed of two coated grain-oriented electrical steel sheets.

It is desirable to prevent generation of a gap between two adjacent layers in a sheet thickness direction at the time of producing the wound core. Therefore, in the two adjacent bent bodies, the length of the steel sheet and the position of the bent region are adjusted such that an outer circumferential length of a flat portion 4 of a bent body disposed inside is equal to an inner circumferential length of a flat portion 4 of a bent body disposed outside.

### (Wound Core Producing Apparatus)

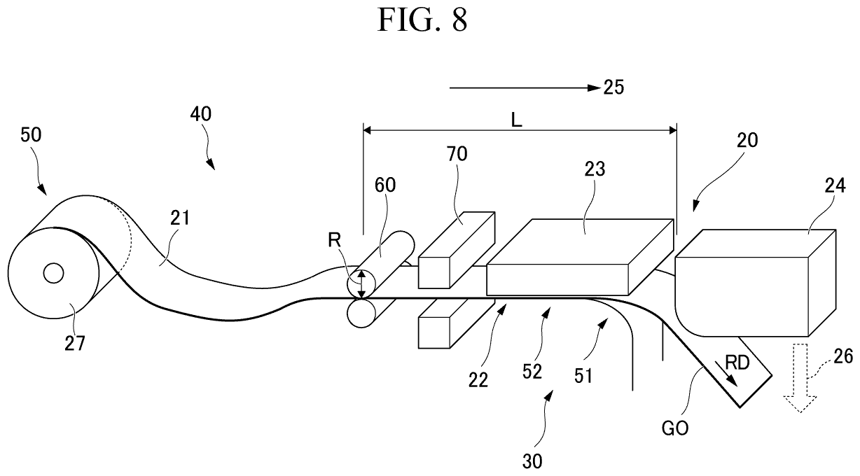

Next, a wound core producing apparatus according to the present disclosure will be described. As illustrated in FIG. 8, the wound core producing apparatus 40 includes a bending device 20 that bends a steel sheet (coated grain-oriented electrical steel sheet) 21, and a feed roll 60 that feeds the steel sheet 21 to the bending device 20. The wound core producing apparatus 40 may further include a decoiler 50, a cutting device 70, a heating device 30, and a laminating device (not illustrated) that laminates bent bodies 1 to produce a wound core 10.

### “Decoiler”

The decoiler 50 unwinds the coated grain-oriented electrical steel sheet 21 from a coil 27 of the coated grain-oriented electrical steel sheet 21. The coated grain-oriented electrical steel sheet 21 unwound from the decoiler 50 is conveyed toward the feed roll 60.

### “Feed Roll”

The feed roll 60 conveys the coated grain-oriented electrical steel sheet 21 to the bending device 20. The feed roll 60 adjusts a conveyance direction of the coated grain-oriented electrical steel sheet 21 immediately before being supplied into the bending device 20. The feed roll 60 adjusts the conveyance direction of the coated grain-oriented electrical steel sheet 21 in a horizontal direction, and then supplies the coated grain-oriented electrical steel sheet 21 to the bending device 20.

The material of an outer circumferential surface of the feed roll 60 is not particularly limited, but examples thereof include rubber, polyvinyl chloride, and phenolic resin. The material of the outer circumferential surface of the feed roll 60 is preferably rubber. The outer circumferential surface is a surface in contact with the coated grain-oriented electrical steel sheet 21. The Shore hardness of the rubber measured at 45° C. is preferably A37 or less. When the Shore hardness of the rubber measured at 45° C. is A37 or less and the following conditional formulas (1) and (2) are satisfied, a wound core can be more stably produced.

Examples of the rubber having a Shore hardness as measured at 45° C. of A37 or less include urethane rubber.

The hardness (Shore hardness) of rubber used for the outer circumferential surface of the feed roll 60 can be measured in accordance with JIS K6253-3:2012. The relative humidity at the time of measurement is, for example, 45% to 53%. For measurement of the Shore hardness, a type A durometer is used. The measurement is performed 3 seconds after pressurization.

The static friction coefficient of the outer circumferential surface of the feed roll 60 is preferably 0.07 to 0.92.

The diameter of the feed roll 60 is, for example, 10 mm to 200 mm. When the diameter of the feed roll is set to 10 mm to 70 mm, it is possible to more stably produce a wound core in which iron loss is suppressed.

The conveyance speed of the coated grain-oriented electrical steel sheet 21 is preferably 5 m/min to 200 m/min. When the conveyance speed satisfies the above range, heat from a die 22 is transmitted to the coated grain-oriented electrical steel sheet 21, and the temperature of a bent region forming portion is easily controlled to 50° C. to 300° C.

The cutting device 70 is installed between the feed roll 60 and the bending device 20. The coated grain-oriented electrical steel sheet 21 may be cut by the cutting device 70, and then bent. After the bending device 20 bends the coated grain-oriented electrical steel sheet 21, the coated grain-oriented electrical steel sheet 21 may be cut by the cutting device 70. The cutting method is not particularly limited. The cutting method is, for example, shearing.

### “Bending Device”

The bending device 20 bends the coated grain-oriented electrical steel sheet 21 conveyed from the feed roll 60. A bent body 1 has a bent region obtained by bending and a flat region adjacent to the bent region. In the bent body 1, a flat portion and a corner portion are alternately continuous. In each corner portion, an angle formed by two adjacent flat portions is substantially 90°.

The bending device 20 includes, for example, a die 22 and a punch 24 for press working.

The punch 24 is shifted in the conveyance direction 25 of the coated grain-oriented electrical steel sheet 21 with respect to the die 22. The die 22 includes a curved portion 51 disposed at an end portion on the punch 24 side, and a flat portion 52 continuously connected to the curved portion 51 from a direction opposite to the punch 24 side and in contact with the coated grain-oriented electrical steel sheet 21. The bending device 20 further includes a guide 23 for fixing the coated grain-oriented electrical steel sheet 21 and a cover (not illustrated). The cover covers the die 22, the punch 24, and the guide 23. After the coated grain-oriented electrical steel sheet 21 is cut by the cutting device 70, the bending device 20 performs bending. The radius of curvature of the curved portion 51 is not particularly limited, but is, for example, 0.5 mm to 5 mm.

The coated grain-oriented electrical steel sheet 21 is conveyed in the conveyance direction 25 and fixed at a position set in advance. Next, the punch 24 pressurizes up to a predetermined position in a pressurization direction 26 with a predetermined force set in advance, so that the bent body 1 having a bent region of a desired bent angle φ is obtained. At this time, the bent body 1 is bent along the curved portion 51 of the die 22 to form a bent region 5. The flat portion 52 of the die 22 consequently forms a flat region 8. The end surface on the die 22 side in the punch 24 also forms a flat region 8. The flat portion 52 of the die 22 and the end surface of the punch 24 form flat regions 8 adjacent to each other with one bent region 5 interposed therebetween.

### “Heating Device”

The heating device 30 heats the die 22. The heating device 30 is not particularly limited as long as it can heat, of the die 22 and a portion to be the bent region 5 (bent region forming portion) of the bent body 1 of the coated grain-oriented electrical steel sheet 21, at least the bent region forming portion. Preferably, it is preferable to heat both the die 22 and the bent region forming portion of the coated grain-oriented electrical steel sheet. Only the die 22 may be heated as long as when the die 22 is heated, heat is transferred from the die 22 to the coated grain-oriented electrical steel sheet 21 and the bent region forming portion can be sufficiently heated. Examples of the heating device 30 include a hot blast generator.

The heating temperature of the die 22 is not limited as long as the temperature range of the portion to be the bent region 5 (bent region forming portion) of the bent body 1 can be set to 70° C. or higher and 300° C. or lower. The heating temperature (achieving temperature) of the bent region can be controlled by, for example, an output (furnace temperature, current value, etc.) of the heating device 30. It is a matter of course that these conditions vary depending on the steel sheet to be used, the heating device 30, and the like, and it is not intended to uniformly indicate and define quantitative conditions. Therefore, in the present disclosure, a heating state is defined by a temperature distribution obtained by temperature measurement described later. However, it is easy for a person skilled in the art who performs heat treatment of a steel sheet as a normal operation to reproduce a desired temperature state in a practical range according to the steel sheet to be used and the heating device 30 based on measurement data of steel sheet temperature as described later, and such control does not hinder implementation of the wound core and the producing method thereof of the present disclosure.

When the temperature of the portion to be the bent region 5 of the bent body 1 is lower than 70° C., it is impossible to suppress iron loss due to generation of deformation twins in the bent region 5. Therefore, the temperature of the portion to be the bent region 5 of the bent body 1 is 70° C. or higher. The temperature is preferably 100° C. or higher, and more preferably 150° C. or higher. In addition, when the temperature of the portion to be the bent region 5 of the bent body 1 exceeds 300° C., the magnetic domain control effect may be lost. Therefore, the upper limit of the temperature of the bent region forming portion is preferably controlled to 300° C. or lower. By heating, of the die 22 and the bent portion forming region, at least the bent portion forming region, the heating device 30 can stably heat the portion to be the bent region 5 (bent region forming portion) of the bent body 1 in the temperature range of 70° C. or higher and 300° C. or lower. Preferably, both are heated. As a result, iron loss of the wound core 10 can be suppressed.

### “Temperature Measurement of Bent Region Forming Portion”

Here, the temperature of the bent region forming portion of the coated grain-oriented electrical steel sheet 21 in bending defined by the present disclosure is measured as follows.

As the temperature, for example, the temperature of the die 22 of the bending device 20 is measured by a thermocouple. Specifically, at a position of 20 mm in a direction opposite to the conveyance direction 25 of the coated grain-oriented electrical steel sheet 21 from a boundary (R-end) between the curved portion 51 and the flat portion 52 of the die 22, thermocouples are installed at three locations that equally divide the entire width of the die 22 in a width direction of the die 22, and measurement is continuously performed by the thermocouples. This temperature is a temperature T (° C.) at a position 20 mm away from a boundary between the curved portion 51 and the flat portion 52 in a direction opposite to the conveyance direction. The average value of the obtained measured values is defined as a temperature T (C) at a position 20 mm away from a boundary between the curved portion 51 and the flat portion 52 in a direction opposite to the conveyance direction (temperature of the bent region forming portion). In addition, since the temperature of the die 22 and the temperature of the coated grain-oriented electrical steel sheet 21 are substantially equal, the surface temperature of the die 22 at a position 20 mm away from a boundary between the curved portion 51 and the flat portion 52 in a direction opposite to the conveyance direction may be regarded as the temperature of the bent region forming portion. The width direction of the die 22 is a direction corresponding to the width direction of the coated grain-oriented electrical steel sheet 21.

The wound core producing apparatus 40 of the present disclosure satisfies the following formula (1) when a distance from a center of the feed roll 60 to an end surface on the die 22 side of the punch 24 along the conveyance direction 25 of the coated grain-oriented electrical steel sheet 21 is denoted by L mm, a diameter of the feed roll 60 is denoted by R mm, a pressure applied to the coated grain-oriented electrical steel sheet 21 by the feed roll 60 is denoted by p MPa, and the temperature at a position 20 mm away from a boundary between the curved portion 51 and the flat portion 52 in a direction opposite to the conveyance direction 25 is denoted by T° C. When the wound core producing apparatus 40 of the present disclosure satisfies the following formulas (1) and (2), it is possible to stably produce a wound core in which iron loss is suppressed. The range of the pressure p MPa satisfies the following formula (2). The temperature at a position 20 mm away from a boundary between the curved portion 51 and the flat portion 52 in a direction opposite to the conveyance direction 25 can be measured by the method described in “Temperature measurement of bent region forming portion”.

$$0.12 \leq ( L \times p ) / ( T \times R ) \leq 0.4 \qquad ( 1 )$$

$$0.4 \leq p \leq 2. \qquad ( 2 )$$

When the above formula (1) is satisfied, the surface temperature of the feed roll 60 can be kept low while the temperature of the bent region forming portion is kept at 70° C. or higher and 300° C. or lower. This makes it possible to stably produce a wound core while suppressing iron loss. In addition, when the above formula (2) is satisfied while the above formula (1) is satisfied, a predetermined tension can be applied to the coated grain-oriented electrical steel sheet 21, and the dimensional accuracy of the wound core can be maintained. When the above formulas (1) and (2) are satisfied, it is possible to stably produce a wound core in which iron loss is suppressed.

The distance L from a center of the feed roll 60 to an end surface on the die 22 side of the punch 24 is preferably 650 mm or more. The distance L from a center of the feed roll 60 to an end surface on the die 22 side of the punch 24 is preferably 1200 mm or less.

The temperature T at a position 20 mm away from a boundary between the curved portion 51 and the flat portion 52 in a direction opposite to the conveyance direction 25 is preferably 70° C. or higher. The temperature T at a position 20 mm away from a boundary between the curved portion 51 and the flat portion 52 in a direction opposite to the conveyance direction 25 may be 220° C. or lower.

### “Laminating Device”

A plurality of bent bodies 1 are laminated in a sheet thickness direction such that the coating of each bent body 1 is on an outer side. The bent bodies 1 are laminated by aligning corner portions 3 and being overlapped in a sheet thickness direction to form a laminated body 2 having a substantially rectangular shape in viewing from the side. As a result, it is possible to obtain the wound core having low iron loss according to the present disclosure. The obtained wound core may be further fixed using a known binding band or fastening tool as necessary.

As described above, since the wound core producing apparatus 40 according to the present disclosure satisfies the above formulas (1) and (2), it is possible to stably produce a wound core in which iron loss is suppressed even when the wound core is produced while heating or the wound core is produced.

The present disclosure is not limited to the above embodiments. The above embodiments are examples, and anything having substantially the identical configuration as the technical idea described in the claims of the present disclosure and exhibiting the same operation and effects is included in the technical scope of the present disclosure. The wound core producing method according to the present disclosure produces a wound core using the above wound core producing method.

### EXAMPLES

Hereinafter, examples (experimental examples) will be described, but the wound core producing apparatus according to the present disclosure is not limited to the following examples. The wound core producing apparatus according to the present disclosure can adopt various conditions as long as the object of the present disclosure is achieved without departing from the gist of the present disclosure. The conditions in the following examples are condition examples adopted to confirm the operability and effects.

### [Produce of Wound Core]

A glass coating (thickness: 1.0 μm) containing forsterite (Mg₂SiO₄) as a primary coating and a secondary coating (thickness: 2.0 μm) containing aluminum phosphate were formed in this order on a base steel sheet (sheet thickness: 0.23 mm) having the above-described chemical composition to produce a coated grain-oriented electrical steel sheet.

The die 22 was heated so that the temperature of bent region forming portions of these coated grain-oriented electrical steel sheets was room temperature (23° C.) or a temperature range of 50° C. to 300° C. as shown in Tables 1A to 8, and bending was performed at a bent angle φ of 45° under the conditions shown in Tables 1A to 8 to obtain a bent body having a bent region. The surface temperature (die heating temperature) of the die 22 at a position 20 mm away from a boundary between the curved portion 51 and the flat portion 52 in a direction opposite to the conveyance direction was measured by the above method. As the material of an outer circumferential surface of the feed roll, urethane rubber was used. The pressing pressure of the roll is a pressure applied to the coated grain-oriented electrical steel sheet by the feed roll. The die heating temperature is a temperature T° C. at a position 20 mm away from a boundary between the curved portion 51 and the flat portion 52 in a direction opposite to the conveyance direction 25. The distance (mm) between the roll and the die is a distance L mm from a center of the feed roll 60 to an end surface on the die 22 side of the punch 24 along the conveyance direction 25 of the steel sheet 21. The calculation results of the above formula (1) are shown in Tables 1A to 8. When the Shore hardness of the urethane rubber of the feed roll used in Nos. 1 to 354 was measured in accordance with JIS K6253-3:2012, the Shore hardness at 45° C. was A37. As a result of measuring the Shore hardness at 45° C. of the styrene-butadiene rubber of the feed roll used in Nos. 355 to 356, the Shore hardness was A80. The relative humidity at the time of Shore hardness measurement was 45% to 53%, and a type A durometer was used for the measurement of the Shore hardness. The measurement was performed 3 seconds after pressurization.

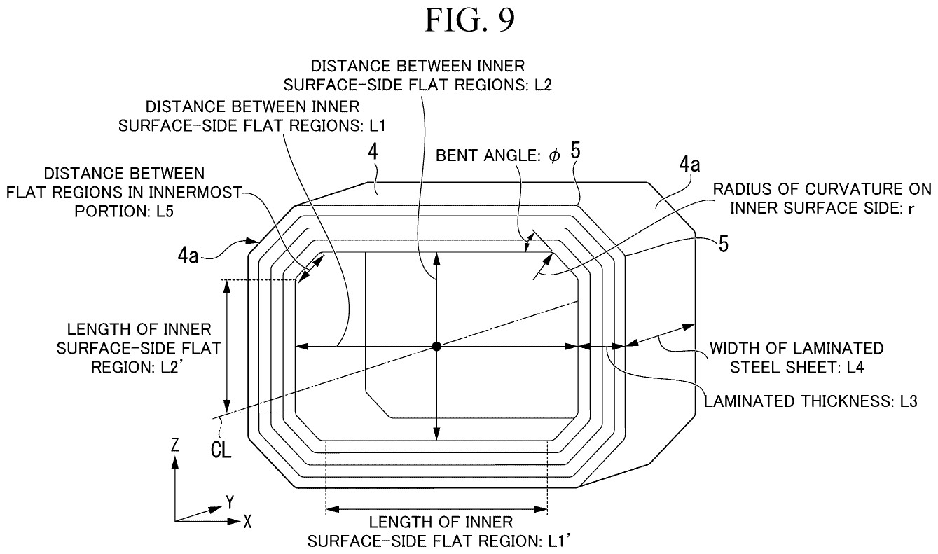

Subsequently, the bent body was laminated in a sheet thickness direction to obtain a wound core having dimensions shown in FIG. 9. L1 is a distance (distance between inner surface-side flat regions) between grain-oriented electrical steel sheets 21 parallel to each other on the innermost circumference of the wound core in a plane cross section parallel to an X-axis direction and including a center CL. L2 is a distance (distance between inner surface-side flat regions) between grain-oriented electrical steel sheets 1 parallel to each other on the innermost circumference of the wound core in a longitudinal cross section parallel to a Z-axis direction and including the center CL. L3 is a laminated thickness (thickness in the stacking direction) of the wound core in the plane cross section parallel to the X-axis direction and including the center CL. L4 is a width of the laminated steel sheet of the wound core in the plane cross section parallel to the X-axis direction and including the center CL. L5 is a distance between flat regions (distance between bent regions) disposed adjacent to each other in the innermost portion of the wound core and so as to form a right angle. In other words, L5 is a length in a longitudinal direction of a flat region having the shortest length among the flat regions of the grain-oriented electrical steel sheet on the innermost circumference. r is a radius of curvature of a bent region on an inner surface side of the wound core, and φ is a bent angle of a bent region of the wound core. The wound core according to the present example has a structure in which a flat region whose inner surface-side flat region distance is L1 is divided at substantially a center of the distance L1, and two cores having a “substantially U-shaped” shape are coupled. In each example, L1: 197 mm, L2: 66 mm, L3: 47 mm, L4: 152.4 mm, L5: 4 mm, and radius of curvature r: 1 mm were set.

### [Evaluation of Iron Loss]

Iron loss was evaluated in building factor. In measurement of the building factor, for each wound core produced under the conditions of Tables 1A to 8, measurement using the excitation current method described in JIS C 2550-1 was performed under the conditions of a frequency of 50 Hz and a magnetic flux density of 1.7 T, and an iron loss value (core iron loss) WA of the wound core was measured. In addition, a sample having a width of 100 mm×a length of 500 mm was collected from a hoop (sheet width of 152.4 mm) of the grain-oriented electrical steel sheet used for the core, and this sample was subjected to measurement by an electrical steel sheet single sheet magnetic properties test using the H-coil method described in JIS C 2556 under the conditions of a frequency of 50 Hz and a magnetic flux density of 1.7 T to measure an iron loss value (iron loss of steel sheet) WB of the material steel sheet single sheet. Then, the building factor (BF) was obtained by dividing the iron loss value WA by the iron loss value WB. The case where BF was 1.18 or less was regarded as acceptable. The results are shown in Tables 1A to 8.

TABLE 1A

| | | Distance | | Pressing | | Building factor | | | |
|---|---|---|---|---|---|---|---|---|---|
| | Die heating | between | Diameter | pressure | Value of | First | Second | Third | Fourth |
| Experiment | temperature | roll and | of roll | of roll | formula | wound | wound | wound | wound |
| No. | (° C.) | die (mm) | (mm) | (MPa) | (1) | core | core | core | core |
| 1 | 70 | 650 | 10 | 0.40 | 0.37 | 1.13 | 1.13 | 1.13 | 1.13 |
| 2 | 70 | 650 | 30 | 0.40 | 0.12 | 1.13 | 1.13 | 1.13 | 1.13 |
| 3 | 70 | 850 | 30 | 0.40 | 0.16 | 1.11 | 1.11 | 1.11 | 1.11 |
| 4 | 70 | 1200 | 30 | 0.40 | 0.23 | 1.11 | 1.11 | 1.11 | 1.11 |
| 5 | 70 | 1200 | 45 | 0.40 | 0.15 | 1.11 | 1.11 | 1.11 | 1.11 |
| 6 | 70 | 650 | 30 | 0.90 | 0.28 | 1.11 | 1.11 | 1.11 | 1.11 |
| 7 | 70 | 650 | 45 | 0.90 | 0.19 | 1.11 | 1.11 | 1.11 | 1.11 |
| 8 | 70 | 650 | 70 | 0.90 | 0.12 | 1.11 | 1.11 | 1.11 | 1.11 |
| 9 | 70 | 850 | 30 | 0.90 | 0.36 | 1.11 | 1.11 | 1.11 | 1.11 |
| 10 | 70 | 850 | 45 | 0.90 | 0.24 | 1.11 | 1.11 | 1.11 | 1.11 |
| 11 | 70 | 850 | 70 | 0.90 | 0.16 | 1.11 | 1.11 | 1.11 | 1.11 |
| 12 | 70 | 650 | 45 | 1.50 | 0.31 | 1.11 | 1.11 | 1.11 | 1.11 |
| 13 | 70 | 650 | 70 | 1.50 | 0.20 | 1.11 | 1.11 | 1.11 | 1.11 |
| 14 | 70 | 650 | 100 | 1.50 | 0.14 | 1.11 | 1.11 | 1.11 | 1.11 |
| 15 | 70 | 1200 | 45 | 0.90 | 0.34 | 1.1 | 1.1 | 1.1 | 1.1 |
| 16 | 70 | 1200 | 70 | 0.90 | 0.22 | 1.1 | 1.1 | 1.1 | 1.1 |
| 17 | 70 | 1200 | 100 | 0.90 | 0.15 | 1.1 | 1.1 | 1.1 | 1.1 |
| 18 | 70 | 850 | 45 | 1.50 | 0.40 | 1.11 | 1.11 | 1.11 | 1.11 |
| 19 | 70 | 850 | 70 | 1.50 | 0.26 | 1.11 | 1.11 | 1.11 | 1.11 |
| 20 | 70 | 850 | 100 | 1.50 | 0.18 | 1.11 | 1.11 | 1.11 | 1.11 |
| 21 | 70 | 1200 | 70 | 1.50 | 0.37 | 1.11 | 1.11 | 1.11 | 1.11 |
| 22 | 70 | 1200 | 100 | 1.50 | 0.26 | 1.11 | 1.11 | 1.11 | 1.11 |
| 23 | 70 | 1200 | 200 | 1.50 | 0.13 | 1.11 | 1.11 | 1.11 | 1.11 |
| 24 | 70 | 1200 | 10 | 2.00 | 0.29 | 1.11 | 1.11 | 1.11 | 1.11 |
| 25 | 90 | 650 | 10 | 0.40 | 0.29 | 1.08 | 1.08 | 1.08 | 1.08 |

TABLE 1B

| | | Distance | | Pressing | | Building factor | | | |
|---|---|---|---|---|---|---|---|---|---|
| | Die heating | between | Diameter | pressure | Value of | First | Second | Third | Fourth |
| Experiment | temperature | roll and | of roll | of roll | formula | wound | wound | wound | wound |
| No. | (° C.) | die (mm) | (mm) | (MPa) | (1) | core | core | core | core |
| 26 | 90 | 850 | 10 | 0.40 | 0.38 | 1.08 | 1.08 | 1.08 | 1.08 |
| 27 | 90 | 850 | 30 | 0.40 | 0.13 | 1.08 | 1.08 | 1.08 | 1.08 |
| 28 | 90 | 1200 | 30 | 0.40 | 0.18 | 1.08 | 1.08 | 1.08 | 1.08 |
| 29 | 90 | 1200 | 45 | 0.40 | 0.12 | 1.08 | 1.08 | 1.08 | 1.08 |
| 30 | 90 | 650 | 30 | 0.90 | 0.22 | 1.08 | 1.08 | 1.08 | 1.08 |
| 31 | 90 | 650 | 45 | 0.90 | 0.14 | 1.07 | 1.07 | 1.07 | 1.07 |
| 32 | 90 | 850 | 30 | 0.90 | 0.28 | 1.08 | 1.08 | 1.08 | 1.08 |
| 33 | 90 | 850 | 45 | 0.90 | 0.19 | 1.08 | 1.08 | 1.08 | 1.08 |
| 34 | 90 | 850 | 70 | 0.90 | 0.12 | 1.08 | 1.08 | 1.08 | 1.08 |
| 35 | 90 | 1200 | 30 | 0.90 | 0.40 | 1.08 | 1.08 | 1.08 | 1.08 |
| 36 | 90 | 1200 | 45 | 0.90 | 0.27 | 1.08 | 1.08 | 1.08 | 1.08 |
| 37 | 90 | 1200 | 70 | 0.90 | 0.17 | 1.08 | 1.08 | 1.08 | 1.08 |
| 38 | 90 | 1200 | 100 | 0.90 | 0.12 | 1.08 | 1.08 | 1.08 | 1.08 |
| 39 | 90 | 650 | 30 | 1.50 | 0.36 | 1.09 | 1.09 | 1.09 | 1.09 |
| 40 | 90 | 650 | 45 | 1.50 | 0.24 | 1.09 | 1.09 | 1.09 | 1.09 |
| 41 | 90 | 650 | 70 | 1.50 | 0.15 | 1.09 | 1.09 | 1.09 | 1.09 |
| 42 | 90 | 850 | 45 | 1.50 | 0.31 | 1.09 | 1.09 | 1.09 | 1.09 |
| 43 | 90 | 850 | 70 | 1.50 | 0.20 | 1.09 | 1.09 | 1.09 | 1.09 |
| 44 | 90 | 850 | 100 | 1.50 | 0.14 | 1.09 | 1.09 | 1.09 | 1.09 |
| 45 | 90 | 1200 | 70 | 1.50 | 0.29 | 1.09 | 1.09 | 1.09 | 1.09 |
| 46 | 90 | 1200 | 100 | 1.50 | 0.20 | 1.09 | 1.09 | 1.09 | 1.09 |
| 47 | 90 | 1200 | 10 | 2.00 | 0.38 | 1.09 | 1.09 | 1.09 | 1.09 |
| 48 | 130 | 650 | 10 | 0.40 | 0.20 | 1.05 | 1.05 | 1.05 | 1.05 |
| 49 | 130 | 850 | 10 | 0.40 | 0.26 | 1.05 | 1.05 | 1.05 | 1.05 |
| 50 | 130 | 1200 | 10 | 0.40 | 0.37 | 1.05 | 1.05 | 1.05 | 1.05 |

TABLE 2A

| | | Distance | | Pressing | | Building factor | | | |
|---|---|---|---|---|---|---|---|---|---|
| | Die heating | between | Diameter | pressure | Value of | First | Second | Third | Fourth |
| Experiment | temperature | roll and | of roll | of roll | formula | wound | wound | wound | wound |
| No. | (° C.) | die (mm) | (mm) | (MPa) | (1) | core | core | core | core |
| 51 | 130 | 1200 | 30 | 0.40 | 0.12 | 1.05 | 1.05 | 1.05 | 1.05 |
| 52 | 130 | 650 | 30 | 0.90 | 0.15 | 1.04 | 1.04 | 1.04 | 1.04 |
| 53 | 130 | 850 | 30 | 0.90 | 0.20 | 1.04 | 1.04 | 1.04 | 1.04 |
| 54 | 130 | 850 | 45 | 0.90 | 0.13 | 1.04 | 1.04 | 1.04 | 1.04 |
| 55 | 130 | 1200 | 30 | 0.90 | 0.28 | 1.04 | 1.04 | 1.04 | 1.04 |
| 56 | 130 | 1200 | 45 | 0.90 | 0.18 | 1.04 | 1.04 | 1.04 | 1.04 |
| 57 | 130 | 1200 | 70 | 0.90 | 0.12 | 1.04 | 1.04 | 1.04 | 1.04 |
| 58 | 130 | 650 | 30 | 1.50 | 0.25 | 1.05 | 1.05 | 1.05 | 1.05 |
| 59 | 130 | 650 | 45 | 1.50 | 0.17 | 1.05 | 1.05 | 1.05 | 1.05 |
| 60 | 130 | 850 | 30 | 1.50 | 0.33 | 1.05 | 1.05 | 1.05 | 1.05 |
| 61 | 130 | 850 | 45 | 1.50 | 0.22 | 1.05 | 1.05 | 1.05 | 1.05 |
| 62 | 130 | 850 | 70 | 1.50 | 0.14 | 1.05 | 1.05 | 1.05 | 1.05 |
| 63 | 130 | 1200 | 45 | 1.50 | 0.31 | 1.05 | 1.05 | 1.05 | 1.05 |
| 64 | 130 | 1200 | 70 | 1.50 | 0.20 | 1.05 | 1.05 | 1.05 | 1.05 |
| 65 | 130 | 1200 | 100 | 1.50 | 0.14 | 1.05 | 1.05 | 1.05 | 1.05 |
| 66 | 220 | 650 | 10 | 0.40 | 0.12 | 1.02 | 1.02 | 1.02 | — |
| 67 | 220 | 850 | 10 | 0.40 | 0.15 | 1.02 | 1.02 | 1.02 | 1.02 |
| 68 | 220 | 1200 | 10 | 0.40 | 0.22 | 1.02 | 1.02 | 1.02 | 1.02 |
| 69 | 220 | 650 | 10 | 0.90 | 0.27 | 1.02 | 1.02 | 1.02 | 1.02 |
| 70 | 220 | 850 | 10 | 0.90 | 0.35 | 1.02 | 1.02 | 1.02 | 1.02 |
| 71 | 220 | 850 | 30 | 0.90 | 0.12 | 1.02 | 1.02 | 1.02 | 1.02 |
| 72 | 220 | 850 | 10 | 0.90 | 0.35 | 1.02 | 1.02 | 1.02 | 1.02 |
| 73 | 220 | 1200 | 30 | 0.90 | 0.16 | 1.02 | 1.02 | 1.02 | 1.02 |

TABLE 2B

| | | Distance | | Pressing | | Building factor | | | |
|---|---|---|---|---|---|---|---|---|---|
| | Die heating | between | Diameter | pressure | Value of | First | Second | Third | Fourth |
| Experiment | temperature | roll and | of roll | of roll | formula | wound | wound | wound | wound |
| No. | (° C.) | die (mm) | (mm) | (MPa) | (1) | core | core | core | core |
| 74 | 220 | 650 | 30 | 1.50 | 0.15 | 1.02 | 1.02 | 1.02 | 1.02 |
| 75 | 220 | 850 | 30 | 1.50 | 0.19 | 1.02 | 1.02 | 1.02 | 1.02 |
| 76 | 220 | 850 | 45 | 1.50 | 0.13 | 1.02 | 1.02 | 1.02 | 1.02 |
| 77 | 220 | 1200 | 30 | 1.50 | 0.27 | 1.02 | 1.02 | 1.02 | 1.02 |
| 78 | 220 | 1200 | 45 | 1.50 | 0.18 | 1.02 | 1.02 | 1.02 | 1.02 |
| 79 | 220 | 1200 | 70 | 1.50 | 0.12 | 1.02 | 1.02 | 1.02 | 1.02 |
| 80 | 23 | 600 | 40 | 0.15 | 0.10 | 1.24 | 1.24 | 1.24 | 1.24 |
| 81 | 23 | 600 | 40 | 1.50 | 0.98 | 1.24 | 1.24 | 1.24 | 1.24 |
| 84 | 50 | 650 | 100 | 0.40 | 0.05 | 1.2 | 1.24 | 1.3 | 1.34 |
| 85 | 50 | 650 | 200 | 0.40 | 0.03 | 1.23 | 1.27 | 1.33 | 1.38 |
| 88 | 50 | 850 | 100 | 0.40 | 0.07 | 1.2 | 1.24 | 1.3 | 1.34 |
| 89 | 50 | 850 | 200 | 0.40 | 0.03 | 1.23 | 1.27 | 1.33 | 1.38 |
| 90 | 50 | 1200 | 10 | 0.40 | 0.96 | 1.19 | 1.27 | 1.36 | 1.38 |
| 91 | 50 | 1200 | 100 | 0.40 | 0.10 | 1.2 | 1.24 | 1.3 | 1.34 |
| 92 | 50 | 1200 | 200 | 0.40 | 0.05 | 1.23 | 1.27 | 1.33 | 1.38 |
| 94 | 50 | 650 | 200 | 0.90 | 0.06 | 1.2 | 1.24 | 1.3 | 1.34 |
| 95 | 50 | 850 | 10 | 0.90 | 1.53 | 1.23 | 1.27 | 1.33 | 1.38 |
| 97 | 50 | 850 | 200 | 0.90 | 0.08 | 1.24 | 1.28 | 1.37 | 1.39 |
| 98 | 50 | 850 | 10 | 0.90 | 1.53 | 1.24 | 1.28 | 1.37 | 1.39 |
| 99 | 50 | 1200 | 10 | 0.90 | 2.16 | 1.24 | 1.28 | 1.37 | 1.39 |
| 100 | 50 | 1200 | 30 | 0.90 | 0.72 | 1.24 | 1.28 | 1.37 | 1.39 |

TABLE 3A

| | | Distance | | Pressing | | Building factor | | | |
|---|---|---|---|---|---|---|---|---|---|
| | Die heating | between | Diameter | pressure | Value of | First | Second | Third | Fourth |
| Experiment | temperature | roll and | of roll | of roll | formula | wound | wound | wound | wound |
| No. | (° C.) | die (mm) | (mm) | (MPa) | (1) | core | core | core | core |
| 101 | 50 | 1200 | 45 | 0.90 | 0.48 | 1.24 | 1.28 | 1.37 | 1.39 |
| 102 | 50 | 1200 | 200 | 0.90 | 0.11 | 1.24 | 1.28 | 1.37 | 1.39 |
| 103 | 50 | 650 | 10 | 1.50 | 1.95 | 1.2 | 1.24 | 1.3 | 1.34 |
| 104 | 50 | 650 | 30 | 1.50 | 0.65 | 1.23 | 1.27 | 1.33 | 1.38 |
| 105 | 50 | 650 | 45 | 1.50 | 0.43 | 1.23 | 1.27 | 1.33 | 1.38 |
| 106 | 50 | 650 | 200 | 1.50 | 0.10 | 1.24 | 1.29 | 1.34 | 1.39 |
| 107 | 50 | 850 | 10 | 1.50 | 2.55 | 1.24 | 1.29 | 1.34 | 1.39 |
| 108 | 50 | 850 | 30 | 1.50 | 0.85 | 1.24 | 1.29 | 1.34 | 1.39 |
| 109 | 50 | 850 | 45 | 1.50 | 0.57 | 1.24 | 1.29 | 1.34 | 1.39 |
| 110 | 50 | 850 | 10 | 1.50 | 2.55 | 1.24 | 1.29 | 1.34 | 1.39 |
| 111 | 50 | 1200 | 10 | 1.50 | 3.60 | 1.24 | 1.29 | 1.34 | 1.39 |
| 112 | 50 | 1200 | 30 | 1.50 | 1.20 | 1.24 | 1.29 | 1.34 | 1.39 |
| 113 | 50 | 1200 | 45 | 1.50 | 0.80 | 1.24 | 1.29 | 1.34 | 1.39 |
| 114 | 50 | 1200 | 70 | 1.50 | 0.51 | 1.24 | 1.29 | 1.34 | 1.39 |
| 115 | 50 | 650 | 30 | 2.00 | 1.15 | 1.24 | 1.29 | 1.34 | 1.39 |
| 116 | 50 | 650 | 45 | 2.00 | 1.73 | 1.24 | 1.29 | 1.34 | 1.39 |
| 117 | 50 | 650 | 70 | 2.00 | 2.69 | 1.24 | 1.29 | 1.34 | 1.39 |
| 118 | 50 | 650 | 100 | 2.00 | 3.85 | 1.24 | 1.29 | 1.34 | 1.39 |
| 119 | 50 | 650 | 200 | 2.00 | 7.69 | 1.24 | 1.29 | 1.34 | 1.39 |
| 120 | 50 | 850 | 30 | 2.00 | 0.88 | 1.24 | 1.29 | 1.34 | 1.39 |
| 121 | 50 | 850 | 45 | 2.00 | 1.32 | 1.24 | 1.29 | 1.34 | 1.39 |
| 122 | 50 | 850 | 70 | 2.00 | 2.06 | 1.24 | 1.29 | 1.34 | 1.39 |
| 123 | 50 | 850 | 100 | 2.00 | 2.94 | 1.24 | 1.29 | 1.34 | 1.39 |
| 124 | 50 | 850 | 200 | 2.00 | 5.88 | 1.24 | 1.29 | 1.34 | 1.39 |
| 125 | 50 | 1200 | 30 | 2.00 | 0.63 | 1.24 | 1.29 | 1.34 | 1.39 |
| 126 | 50 | 1200 | 45 | 2.00 | 0.94 | 1.24 | 1.29 | 1.34 | 1.39 |

TABLE 3B

| | | Distance | | Pressing | | Building factor | | | |
|---|---|---|---|---|---|---|---|---|---|
| | Die heating | between | Diameter | pressure | Value of | First | Second | Third | Fourth |
| Experiment | temperature | roll and | of roll | of roll | formula | wound | wound | wound | wound |
| No. | (° C.) | die (mm) | (mm) | (MPa) | (1) | core | core | core | core |
| 127 | 50 | 1200 | 70 | 2.00 | 1.46 | 1.24 | 1.29 | 1.34 | 1.39 |
| 128 | 50 | 1200 | 100 | 2.00 | 2.08 | 1.24 | 1.29 | 1.34 | 1.39 |
| 129 | 50 | 1200 | 200 | 2.00 | 4.17 | 1.24 | 1.29 | 1.34 | 1.39 |
| 130 | 70 | 650 | 45 | 0.40 | 0.08 | 1.19 | 1.24 | 1.34 | 1.39 |
| 131 | 70 | 650 | 70 | 0.40 | 0.05 | 1.19 | 1.24 | 1.34 | 1.39 |
| 132 | 70 | 650 | 100 | 0.40 | 0.04 | 1.19 | 1.24 | 1.34 | 1.39 |
| 133 | 70 | 650 | 200 | 0.40 | 0.02 | 1.19 | 1.24 | 1.34 | 1.39 |
| 134 | 70 | 850 | 10 | 0.40 | 0.49 | 1.19 | 1.24 | 1.34 | 1.39 |
| 135 | 70 | 850 | 45 | 0.40 | 0.11 | 1.19 | 1.24 | 1.34 | 1.39 |
| 136 | 70 | 850 | 70 | 0.40 | 0.07 | 1.19 | 1.24 | 1.34 | 1.39 |
| 137 | 70 | 850 | 100 | 0.40 | 0.05 | 1.19 | 1.24 | 1.34 | 1.39 |
| 138 | 70 | 850 | 200 | 0.40 | 0.02 | 1.19 | 1.24 | 1.34 | 1.39 |
| 139 | 70 | 1200 | 10 | 0.40 | 0.69 | 1.19 | 1.24 | 1.34 | 1.39 |
| 140 | 70 | 1200 | 70 | 0.40 | 0.10 | 1.19 | 1.24 | 1.34 | 1.39 |
| 141 | 70 | 1200 | 100 | 0.40 | 0.07 | 1.19 | 1.24 | 1.34 | 1.39 |
| 142 | 70 | 1200 | 200 | 0.40 | 0.03 | 1.19 | 1.24 | 1.34 | 1.39 |
| 143 | 70 | 650 | 10 | 0.90 | 0.84 | 1.19 | 1.24 | 1.34 | 1.39 |
| 144 | 70 | 650 | 100 | 0.90 | 0.08 | 1.19 | 1.24 | 1.34 | 1.39 |
| 145 | 70 | 650 | 200 | 0.90 | 0.04 | 1.19 | 1.24 | 1.34 | 1.39 |
| 146 | 70 | 850 | 10 | 0.90 | 1.09 | 1.19 | 1.24 | 1.34 | 1.39 |
| 147 | 70 | 850 | 100 | 0.90 | 0.11 | 1.19 | 1.24 | 1.34 | 1.39 |
| 148 | 70 | 850 | 200 | 0.90 | 0.05 | 1.19 | 1.24 | 1.34 | 1.39 |
| 149 | 70 | 850 | 10 | 0.90 | 1.09 | 1.19 | 1.24 | 1.34 | 1.39 |
| 150 | 70 | 1200 | 10 | 0.90 | 1.54 | 1.19 | 1.24 | 1.34 | 1.39 |

TABLE 4A

| | | Distance | | Pressing | | Building factor | | | |
|---|---|---|---|---|---|---|---|---|---|
| | Die heating | between | Diameter | pressure | Value of | First | Second | Third | Fourth |
| Experiment | temperature | roll and | of roll | of roll | formula | wound | wound | wound | wound |
| No. | (° C.) | die (mm) | (mm) | (MPa) | (1) | core | core | core | core |
| 151 | 70 | 1200 | 30 | 0.90 | 0.51 | 1.19 | 1.24 | 1.34 | 1.39 |
| 152 | 70 | 1200 | 200 | 0.90 | 0.08 | 1.24 | 1.19 | 1.34 | 1.39 |
| 153 | 70 | 650 | 10 | 1.50 | 1.39 | 1.19 | 1.24 | 1.34 | 1.39 |
| 154 | 70 | 650 | 30 | 1.50 | 0.46 | 1.19 | 1.24 | 1.34 | 1.39 |
| 155 | 70 | 650 | 200 | 1.50 | 0.07 | 1.19 | 1.24 | 1.34 | 1.39 |
| 156 | 70 | 850 | 10 | 1.50 | 1.82 | 1.19 | 1.24 | 1.34 | 1.39 |
| 157 | 70 | 850 | 30 | 1.50 | 0.61 | 1.19 | 1.24 | 1.34 | 1.39 |
| 158 | 70 | 850 | 200 | 1.50 | 0.09 | 1.19 | 1.24 | 1.34 | 1.39 |
| 159 | 70 | 850 | 10 | 1.50 | 1.82 | 1.19 | 1.24 | 1.34 | 1.39 |
| 160 | 70 | 1200 | 10 | 1.50 | 2.57 | 1.19 | 1.24 | 1.34 | 1.39 |
| 161 | 70 | 1200 | 30 | 1.50 | 0.86 | 1.19 | 1.24 | 1.34 | 1.39 |
| 162 | 70 | 1200 | 45 | 1.50 | 0.57 | 1.19 | 1.24 | 1.34 | 1.39 |
| 163 | 70 | 650 | 10 | 2.00 | 0.54 | 1.19 | 1.24 | 1.34 | 1.39 |
| 164 | 70 | 650 | 30 | 2.00 | 1.62 | 1.19 | 1.24 | 1.34 | 1.39 |
| 165 | 70 | 650 | 45 | 2.00 | 2.42 | 1.19 | 1.24 | 1.34 | 1.39 |
| 166 | 70 | 650 | 70 | 2.00 | 3.77 | 1.19 | 1.24 | 1.34 | 1.39 |
| 167 | 70 | 650 | 100 | 2.00 | 5.38 | 1.19 | 1.24 | 1.34 | 1.39 |
| 168 | 70 | 650 | 200 | 2.00 | 10.77 | 1.19 | 1.24 | 1.34 | 1.39 |
| 169 | 70 | 850 | 10 | 2.00 | 0.41 | 1.19 | 1.24 | 1.34 | 1.39 |
| 170 | 70 | 850 | 30 | 2.00 | 1.24 | 1.19 | 1.24 | 1.34 | 1.39 |
| 171 | 70 | 850 | 45 | 2.00 | 1.85 | 1.19 | 1.24 | 1.34 | 1.39 |
| 172 | 70 | 850 | 70 | 2.00 | 2.88 | 1.19 | 1.24 | 1.34 | 1.39 |
| 173 | 70 | 850 | 100 | 2.00 | 4.12 | 1.19 | 1.24 | 1.34 | 1.39 |
| 174 | 70 | 850 | 200 | 2.00 | 8.24 | 1.19 | 1.24 | 1.34 | 1.39 |
| 175 | 70 | 1200 | 30 | 2.00 | 0.88 | 1.19 | 1.24 | 1.34 | 1.39 |

TABLE 4B

| | | Distance | | Pressing | | Building factor | | | |
|---|---|---|---|---|---|---|---|---|---|
| | Die heating | between | Diameter | pressure | Value of | First | Second | Third | Fourth |
| Experiment | temperature | roll and | of roll | of roll | formula | wound | wound | wound | wound |
| No. | (° C.) | die (mm) | (mm) | (MPa) | (1) | core | core | core | core |
| 176 | 70 | 1200 | 45 | 2.00 | 1.31 | 1.19 | 1.24 | 1.34 | 1.39 |
| 177 | 70 | 1200 | 70 | 2.00 | 2.04 | 1.19 | 1.24 | 1.34 | 1.39 |
| 178 | 70 | 1200 | 100 | 2.00 | 2.92 | 1.19 | 1.24 | 1.34 | 1.39 |
| 179 | 70 | 1200 | 200 | 2.00 | 5.83 | 1.19 | 1.24 | 1.34 | 1.39 |
| 180 | 90 | 650 | 30 | 0.40 | 0.10 | 1.19 | 1.24 | 1.34 | — |
| 181 | 90 | 650 | 45 | 0.40 | 0.06 | 1.19 | 1.24 | 1.34 | — |
| 182 | 90 | 650 | 70 | 0.40 | 0.04 | 1.19 | 1.24 | 1.34 | — |
| 183 | 90 | 650 | 100 | 0.40 | 0.03 | 1.19 | 1.24 | 1.34 | — |
| 184 | 90 | 650 | 200 | 0.40 | 0.01 | 1.19 | 1.24 | 1.34 | — |
| 185 | 90 | 850 | 45 | 0.40 | 0.08 | 1.19 | 1.24 | 1.34 | — |
| 186 | 90 | 850 | 70 | 0.40 | 0.05 | 1.19 | 1.24 | 1.34 | — |
| 187 | 90 | 850 | 100 | 0.40 | 0.04 | 1.19 | 1.24 | 1.34 | — |
| 188 | 90 | 850 | 200 | 0.40 | 0.02 | 1.19 | 1.24 | 1.34 | — |
| 189 | 90 | 1200 | 10 | 0.40 | 0.53 | 1.19 | 1.24 | 1.34 | — |
| 190 | 90 | 1200 | 70 | 0.40 | 0.08 | 1.19 | 1.24 | 1.34 | — |
| 191 | 90 | 1200 | 100 | 0.40 | 0.05 | 1.19 | 1.24 | 1.34 | — |
| 192 | 90 | 1200 | 200 | 0.40 | 0.03 | 1.19 | 1.24 | 1.34 | — |
| 193 | 90 | 650 | 10 | 0.90 | 0.65 | 1.19 | 1.24 | 1.34 | — |
| 194 | 90 | 650 | 70 | 0.90 | 0.09 | 1.19 | 1.24 | 1.34 | — |
| 195 | 90 | 650 | 100 | 0.90 | 0.07 | 1.19 | 1.24 | 1.34 | — |
| 196 | 90 | 650 | 200 | 0.90 | 0.03 | 1.19 | 1.24 | 1.34 | — |
| 197 | 90 | 850 | 10 | 0.90 | 0.85 | 1.19 | 1.24 | 1.34 | — |
| 198 | 90 | 850 | 100 | 0.90 | 0.09 | 1.19 | 1.24 | 1.34 | — |
| 199 | 90 | 850 | 200 | 0.90 | 0.04 | 1.19 | 1.24 | 1.34 | — |
| 200 | 90 | 850 | 10 | 0.90 | 0.85 | 1.19 | 1.24 | 1.34 | — |

TABLE 5A

| | | Distance | | Pressing | | Building factor | | | |
|---|---|---|---|---|---|---|---|---|---|
| | Die heating | between | Diameter | pressure | Value of | First | Second | Third | Fourth |
| Experiment | temperature | roll and | of roll | of roll | formula | wound | wound | wound | wound |
| No. | (° C.) | die (mm) | (mm) | (MPa) | (1) | core | core | core | core |
| 201 | 90 | 1200 | 10 | 0.90 | 1.20 | 1.19 | 1.24 | 1.34 | — |
| 202 | 90 | 1200 | 200 | 0.90 | 0.06 | 1.19 | 1.24 | 1.34 | — |
| 203 | 90 | 650 | 10 | 1.50 | 1.08 | 1.19 | 1.24 | 1.34 | — |
| 204 | 90 | 650 | 100 | 1.50 | 0.11 | 1.19 | 1.24 | 1.34 | — |
| 205 | 90 | 650 | 200 | 1.50 | 0.05 | 1.19 | 1.24 | 1.34 | — |
| 206 | 90 | 850 | 10 | 1.50 | 1.42 | 1.19 | 1.24 | 1.34 | — |
| 207 | 90 | 850 | 30 | 1.50 | 0.47 | 1.19 | 1.24 | 1.34 | — |
| 208 | 90 | 850 | 200 | 1.50 | 0.07 | 1.19 | 1.24 | 1.34 | — |
| 209 | 90 | 850 | 10 | 1.50 | 1.42 | 1.19 | 1.24 | 1.34 | — |
| 210 | 90 | 1200 | 10 | 1.50 | 2.00 | 1.19 | 1.24 | 1.34 | — |
| 211 | 90 | 1200 | 30 | 1.50 | 0.67 | 1.19 | 1.24 | 1.34 | — |
| 212 | 90 | 1200 | 45 | 1.50 | 0.44 | 1.19 | 1.24 | 1.34 | — |
| 213 | 90 | 1200 | 200 | 1.50 | 0.10 | 1.19 | 1.24 | 1.34 | — |
| 214 | 90 | 650 | 10 | 2.00 | 0.69 | 1.19 | 1.24 | 1.34 | — |
| 215 | 90 | 650 | 30 | 2.00 | 2.08 | 1.19 | 1.24 | 1.34 | — |
| 216 | 90 | 650 | 45 | 2.00 | 3.12 | 1.19 | 1.24 | 1.34 | — |
| 217 | 90 | 650 | 70 | 2.00 | 4.85 | 1.19 | 1.24 | 1.34 | — |
| 218 | 90 | 650 | 100 | 2.00 | 6.92 | 1.19 | 1.24 | 1.34 | — |
| 219 | 90 | 650 | 200 | 2.00 | 13.85 | 1.19 | 1.24 | 1.34 | — |
| 220 | 90 | 850 | 10 | 2.00 | 0.53 | 1.19 | 1.24 | 1.34 | — |
| 221 | 90 | 850 | 30 | 2.00 | 1.59 | 1.19 | 1.24 | 1.34 | — |
| 222 | 90 | 850 | 45 | 2.00 | 2.38 | 1.19 | 1.24 | 1.34 | — |
| 223 | 90 | 850 | 70 | 2.00 | 3.71 | 1.19 | 1.24 | 1.34 | — |
| 224 | 90 | 850 | 100 | 2.00 | 5.29 | 1.19 | 1.24 | 1.34 | — |
| 225 | 90 | 850 | 200 | 2.00 | 10.59 | 1.19 | 1.24 | 1.34 | — |

TABLE 5B

| | | Distance | | Pressing | | Building factor | | | |
|---|---|---|---|---|---|---|---|---|---|
| | Die heating | between | Diameter | pressure | Value of | First | Second | Third | Fourth |
| Experiment | temperature | roll and | of roll | of roll | formula | wound | wound | wound | wound |
| No. | (° C.) | die (mm) | (mm) | (MPa) | (1) | core | core | core | core |
| 226 | 90 | 1200 | 30 | 2.00 | 1.13 | 1.19 | 1.24 | — | — |
| 227 | 90 | 1200 | 45 | 2.00 | 1.69 | 1.19 | 1.24 | — | — |
| 228 | 90 | 1200 | 70 | 2.00 | 2.63 | 1.19 | 1.24 | — | — |
| 229 | 90 | 1200 | 100 | 2.00 | 3.75 | 1.19 | 1.24 | — | — |
| 230 | 90 | 1200 | 200 | 2.00 | 7.50 | 1.19 | 1.24 | — | — |
| 231 | 130 | 650 | 30 | 0.40 | 0.07 | 1.08 | 1.1 | — | — |
| 232 | 130 | 650 | 45 | 0.40 | 0.04 | 1.08 | 1.1 | — | — |
| 233 | 130 | 650 | 70 | 0.40 | 0.03 | 1.08 | 1.1 | — | — |
| 234 | 130 | 650 | 100 | 0.40 | 0.02 | 1.08 | 1.1 | — | — |
| 235 | 130 | 650 | 200 | 0.40 | 0.01 | 1.08 | 1.1 | — | — |
| 236 | 130 | 850 | 30 | 0.40 | 0.09 | 1.08 | 1.1 | — | — |
| 237 | 130 | 850 | 45 | 0.40 | 0.06 | 1.08 | 1.1 | — | — |
| 238 | 130 | 850 | 70 | 0.40 | 0.04 | 1.08 | 1.1 | — | — |
| 239 | 130 | 850 | 100 | 0.40 | 0.03 | 1.08 | 1.1 | — | — |
| 240 | 130 | 850 | 200 | 0.40 | 0.01 | 1.08 | 1.1 | — | — |
| 241 | 130 | 1200 | 45 | 0.40 | 0.08 | 1.08 | 1.1 | — | — |
| 242 | 130 | 1200 | 70 | 0.40 | 0.05 | 1.08 | 1.1 | — | — |
| 243 | 130 | 1200 | 100 | 0.40 | 0.04 | 1.08 | 1.1 | — | — |
| 244 | 130 | 1200 | 200 | 0.40 | 0.02 | 1.08 | 1.1 | — | — |
| 245 | 130 | 650 | 10 | 0.90 | 0.45 | 1.08 | 1.1 | — | — |
| 246 | 130 | 650 | 45 | 0.90 | 0.10 | 1.08 | 1.1 | — | — |
| 247 | 130 | 650 | 70 | 0.90 | 0.06 | 1.08 | 1.1 | — | — |
| 248 | 130 | 650 | 100 | 0.90 | 0.05 | 1.08 | 1.1 | — | — |
| 249 | 130 | 650 | 200 | 0.90 | 0.02 | 1.08 | 1.1 | — | — |
| 250 | 130 | 850 | 10 | 0.90 | 0.59 | 1.08 | 1.1 | — | — |

TABLE 6A

| | | Distance | | Pressing | | Building factor | | | |
|---|---|---|---|---|---|---|---|---|---|
| | Die heating | between | Diameter | pressure | Value of | First | Second | Third | Fourth |
| Experiment | temperature | roll and | of roll | of roll | formula | wound | wound | wound | wound |
| No. | (° C.) | die (mm) | (mm) | (MPa) | (1) | core | core | core | core |
| 251 | 130 | 850 | 70 | 0.90 | 0.08 | 1.08 | 1.1 | — | — |
| 252 | 130 | 850 | 100 | 0.90 | 0.06 | 1.08 | 1.1 | — | — |
| 253 | 130 | 850 | 200 | 0.90 | 0.03 | 1.08 | 1.1 | — | — |
| 254 | 130 | 850 | 10 | 0.90 | 0.59 | 1.08 | 1.1 | — | — |
| 255 | 130 | 1200 | 10 | 0.90 | 0.83 | 1.08 | 1.1 | — | — |
| 256 | 130 | 1200 | 100 | 0.90 | 0.08 | 1.08 | 1.1 | — | — |
| 257 | 130 | 1200 | 200 | 0.90 | 0.04 | 1.08 | 1.1 | — | — |
| 258 | 130 | 650 | 10 | 1.50 | 0.75 | 1.08 | 1.1 | — | — |
| 259 | 130 | 650 | 70 | 1.50 | 0.11 | 1.08 | 1.1 | — | — |
| 260 | 130 | 650 | 100 | 1.50 | 0.08 | 1.08 | 1.1 | — | — |
| 261 | 130 | 650 | 200 | 1.50 | 0.04 | 1.08 | 1.1 | — | — |
| 262 | 130 | 850 | 10 | 1.50 | 0.98 | 1.08 | 1.1 | — | — |
| 263 | 130 | 850 | 100 | 1.50 | 0.10 | 1.08 | 1.1 | — | — |
| 264 | 130 | 850 | 200 | 1.50 | 0.05 | 1.08 | 1.1 | — | — |
| 265 | 130 | 850 | 10 | 1.50 | 0.98 | 1.08 | 1.1 | — | — |
| 266 | 130 | 1200 | 10 | 1.50 | 1.38 | 1.08 | 1.1 | — | — |
| 267 | 130 | 1200 | 30 | 1.50 | 0.46 | 1.08 | 1.1 | — | — |
| 268 | 130 | 1200 | 200 | 1.50 | 0.07 | 1.08 | 1.1 | — | — |
| 269 | 130 | 650 | 10 | 2.00 | 1.00 | 1.08 | 1.1 | — | — |
| 270 | 130 | 650 | 30 | 2.00 | 3.00 | 1.08 | 1.1 | — | — |
| 271 | 130 | 650 | 45 | 2.00 | 4.50 | 1.08 | 1.1 | — | — |
| 272 | 130 | 650 | 70 | 2.00 | 7.00 | 1.08 | 1.1 | — | — |
| 273 | 130 | 650 | 100 | 2.00 | 10.00 | 1.08 | 1.1 | — | — |
| 274 | 130 | 650 | 200 | 2.00 | 20.00 | 1.08 | 1.1 | — | — |
| 275 | 130 | 850 | 10 | 2.00 | 0.76 | 1.08 | 1.1 | — | — |

TABLE 6B

| | | Distance | | Pressing | | Building factor | | | |
|---|---|---|---|---|---|---|---|---|---|
| | Die heating | between | Diameter | pressure | Value of | First | Second | Third | Fourth |
| Experiment | temperature | roll and | of roll | of roll | formula | wound | wound | wound | wound |
| No. | (° C.) | die (mm) | (mm) | (MPa) | (1) | core | core | core | core |
| 276 | 130 | 850 | 30 | 2.00 | 2.29 | 1.08 | 1.1 | — | — |
| 273 | 130 | 850 | 45 | 2.00 | 3.44 | 1.08 | 1.1 | — | — |
| 278 | 130 | 850 | 70 | 2.00 | 5.35 | 1.08 | 1.1 | — | — |
| 279 | 130 | 850 | 100 | 2.00 | 7.65 | 1.08 | 1.1 | — | — |
| 280 | 130 | 850 | 200 | 2.00 | 15.29 | 1.08 | 1.1 | — | — |
| 281 | 130 | 1200 | 10 | 2.00 | 0.54 | 1.08 | 1.1 | — | — |
| 282 | 130 | 1200 | 30 | 2.00 | 1.63 | 1.08 | 1.1 | — | — |
| 283 | 130 | 1200 | 45 | 2.00 | 2.44 | 1.08 | 1.1 | — | — |
| 284 | 130 | 1200 | 70 | 2.00 | 3.79 | 1.08 | 1.1 | — | — |
| 285 | 130 | 1200 | 100 | 2.00 | 5.42 | 1.08 | 1.1 | — | — |
| 286 | 130 | 1200 | 200 | 2.00 | 10.83 | 1.08 | 1.1 | — | — |
| 287 | 220 | 650 | 30 | 0.40 | 0.04 | 1.03 | — | — | — |
| 288 | 220 | 650 | 45 | 0.40 | 0.03 | 1.03 | — | — | — |
| 289 | 220 | 650 | 70 | 0.40 | 0.02 | 1.03 | — | — | — |
| 290 | 220 | 650 | 100 | 0.40 | 0.01 | 1.03 | — | — | — |
| 291 | 220 | 650 | 200 | 0.40 | 0.01 | 1.03 | — | — | — |
| 292 | 220 | 850 | 30 | 0.40 | 0.05 | 1.03 | — | — | — |
| 293 | 220 | 850 | 45 | 0.40 | 0.03 | 1.03 | — | — | — |
| 294 | 220 | 850 | 70 | 0.40 | 0.02 | 1.03 | — | — | — |
| 295 | 220 | 850 | 100 | 0.40 | 0.02 | 1.03 | — | — | — |
| 296 | 220 | 850 | 200 | 0.40 | 0.01 | 1.03 | — | — | — |
| 297 | 220 | 1200 | 30 | 0.40 | 0.07 | 1.03 | — | — | — |
| 298 | 220 | 1200 | 45 | 0.40 | 0.05 | 1.03 | — | — | — |
| 299 | 220 | 1200 | 70 | 0.40 | 0.03 | 1.03 | — | — | — |
| 300 | 220 | 1200 | 100 | 0.40 | 0.02 | 1.03 | — | — | — |

TABLE 7A

| | | Distance | | Pressing | | Building factor | | | |
|---|---|---|---|---|---|---|---|---|---|
| | Die heating | between | Diameter | pressure | Value of | First | Second | Third | Fourth |
| Experiment | temperature | roll and | of roll | of roll | formula | wound | wound | wound | wound |
| No. | (° C.) | die (mm) | (mm) | (MPa) | (1) | core | core | core | core |
| 301 | 220 | 1200 | 200 | 0.40 | 0.01 | 1.03 | — | — | — |
| 302 | 220 | 650 | 30 | 0.90 | 0.09 | 1.03 | — | — | — |
| 303 | 220 | 650 | 45 | 0.90 | 0.06 | 1.03 | — | — | — |
| 304 | 220 | 650 | 70 | 0.90 | 0.04 | 1.03 | — | — | — |
| 305 | 220 | 650 | 100 | 0.90 | 0.03 | 1.03 | — | — | — |
| 306 | 220 | 650 | 200 | 0.90 | 0.01 | 1.03 | — | — | — |
| 307 | 220 | 850 | 45 | 0.90 | 0.08 | 1.03 | — | — | — |
| 308 | 220 | 850 | 70 | 0.90 | 0.05 | 1.03 | — | — | — |
| 309 | 220 | 850 | 100 | 0.90 | 0.03 | 1.03 | — | — | — |
| 310 | 220 | 850 | 200 | 0.90 | 0.02 | 1.03 | — | — | — |
| 311 | 220 | 1200 | 10 | 0.90 | 0.49 | 1.03 | — | — | — |
| 312 | 220 | 1200 | 45 | 0.90 | 0.11 | 1.03 | — | — | — |
| 313 | 220 | 1200 | 70 | 0.90 | 0.07 | 1.03 | — | — | — |
| 314 | 220 | 1200 | 100 | 0.90 | 0.05 | 1.03 | — | — | — |
| 315 | 220 | 1200 | 200 | 0.90 | 0.02 | 1.03 | — | — | — |
| 316 | 220 | 650 | 10 | 1.50 | 0.44 | 1.03 | — | — | — |
| 317 | 220 | 650 | 45 | 1.50 | 0.10 | 1.03 | — | — | — |
| 318 | 220 | 650 | 70 | 1.50 | 0.06 | 1.03 | — | — | — |
| 319 | 220 | 650 | 100 | 1.50 | 0.04 | 1.03 | — | — | — |
| 320 | 220 | 650 | 200 | 1.50 | 0.02 | 1.03 | — | — | — |
| 321 | 220 | 850 | 10 | 1.50 | 0.58 | 1.03 | — | — | — |
| 322 | 220 | 850 | 70 | 1.50 | 0.08 | 1.03 | — | — | — |
| 323 | 220 | 850 | 100 | 1.50 | 0.06 | 1.03 | — | — | — |
| 324 | 220 | 850 | 200 | 1.50 | 0.03 | 1.03 | — | — | — |

TABLE 7B

| | | Distance | | Pressing | | Building factor | | | |
|---|---|---|---|---|---|---|---|---|---|
| | Die heating | between | Diameter | pressure | Value of | First | Second | Third | Fourth |
| Experiment | temperature | roll and | of roll | of roll | formula | wound | wound | wound | wound |
| No. | (° C.) | die (mm) | (mm) | (MPa) | (1) | core | core | core | core |
| 325 | 220 | 850 | 10 | 1.50 | 0.58 | 1.03 | — | — | — |
| 326 | 220 | 1200 | 10 | 1.50 | 0.82 | 1.03 | — | — | — |
| 327 | 220 | 1200 | 100 | 1.50 | 0.08 | 1.03 | — | — | — |
| 328 | 220 | 1200 | 200 | 1.50 | 0.04 | 1.03 | — | — | — |
| 329 | 220 | 650 | 10 | 2.00 | 1.69 | 1.03 | — | — | — |
| 330 | 220 | 650 | 30 | 2.00 | 5.08 | 1.03 | — | — | — |
| 331 | 220 | 650 | 45 | 2.00 | 7.62 | 1.03 | — | — | — |
| 332 | 220 | 650 | 70 | 2.00 | 11.85 | 1.03 | — | — | — |
| 333 | 220 | 650 | 100 | 2.00 | 16.92 | 1.03 | — | — | — |
| 334 | 220 | 650 | 200 | 2.00 | 33.85 | 1.03 | — | — | — |
| 335 | 220 | 850 | 10 | 2.00 | 1.29 | 1.03 | — | — | — |
| 336 | 220 | 850 | 30 | 2.00 | 3.88 | 1.03 | — | — | — |
| 337 | 220 | 850 | 45 | 2.00 | 5.82 | 1.03 | — | — | — |
| 338 | 220 | 850 | 70 | 2.00 | 9.06 | 1.03 | — | — | — |
| 339 | 220 | 850 | 100 | 2.00 | 12.94 | 1.03 | — | — | — |
| 340 | 220 | 850 | 200 | 2.00 | 25.88 | 1.03 | — | — | — |
| 341 | 220 | 1200 | 10 | 2.00 | 0.92 | 1.03 | — | — | — |
| 342 | 220 | 1200 | 30 | 2.00 | 2.75 | 1.03 | — | — | — |
| 343 | 220 | 1200 | 45 | 2.00 | 4.13 | 1.03 | — | — | — |
| 344 | 220 | 1200 | 70 | 2.00 | 6.42 | 1.03 | — | — | — |
| 345 | 220 | 1200 | 100 | 2.00 | 9.17 | 1.03 | — | — | — |
| 346 | 220 | 1200 | 200 | 2.00 | 18.33 | 1.03 | — | — | — |

TABLE 8

| | | Distance | | Pressing | | Building factor | | | |
|---|---|---|---|---|---|---|---|---|---|
| | Die heating | between | Diameter | pressure | Value of | First | Second | Third | Fourth |
| Experiment | temperature | roll and | of roll | of roll | formula | wound | wound | wound | wound |
| No. | (° C.) | die (mm) | (mm) | (MPa) | (1) | core | core | core | core |
| 347 | 23 | 1200 | 200 | 2.10 | 0.55 | 1.24 | 1.24 | 1.24 | 1.24 |
| 348 | 50 | 650 | 30 | 0.30 | 0.13 | 1.24 | 1.24 | 1.24 | 1.24 |
| 349 | 50 | 650 | 30 | 2.10 | 0.91 | 1.24 | 1.24 | 1.24 | 1.24 |
| 350 | 70 | 650 | 45 | 2.10 | 0.43 | 1.24 | 1.24 | 1.24 | 1.24 |
| 351 | 90 | 650 | 70 | 0.30 | 0.03 | 1.24 | 1.24 | 1.24 | 1.24 |
| 352 | 90 | 650 | 70 | 2.10 | 0.22 | 1.24 | 1.24 | 1.24 | 1.24 |
| 353 | 130 | 800 | 100 | 2.10 | 0.13 | 1.24 | 1.24 | 1.24 | 1.24 |
| 354 | 220 | 1100 | 10 | 0.30 | 0.15 | 1.24 | 1.24 | 1.24 | 1.24 |
| 355 | 70 | 650 | 70 | 0.90 | 0.12 | 1.12 | 1.12 | 1.12 | 1.12 |
| 356 | 130 | 850 | 70 | 1.50 | 0.14 | 1.06 | 1.06 | 1.06 | 1.06 |

On the other hand, as shown in the results of Tables 1 to 8, in Experiment Nos. 1 to 79 and 355 to 356, the pressure applied to the steel sheet by the feed roll was 0.40 MPa to 2.00 MPa, and the above formula (1) was satisfied, so that the wound core could be stably produced while suppressing iron loss. As shown in the comparison between No. 8 and No. 355 and the comparison between No. 62 and No. 356, when the Shore hardness of the rubber of the feed roll was more than A37, the building factor increased. On the other hand, since Experiment Nos. 80 to 179 did not satisfy the above formula (1), the building factor increased every time the wound core was produced. In addition, in Experiment Nos. 180 to 346, since the temperature (die heating temperature) of the die was 90° C. or higher, it was not possible to produce the wound core from the middle of produce. In Nos. 347 to 354, since the formula (2) was not satisfied, the length of the steel sheet could not be appropriately controlled, and the building factor increased.

### [Field of Industrial Application]

According to the present disclosure, it is possible to stably produce a wound core in which iron loss is suppressed. Therefore, industrial applicability is large.

### BRIEF DESCRIPTION OF THE REFERENCE SYMBOLS

1 Bent body
2 Laminated body
3 Corner portion
4, 4a, 4b Flat portion
5, 5a, 5b Bent region
6 Gap
8 Flat region
10 Wound core
20 Bending device
30 Heating device
40 Producing apparatus
21 Coated grain-oriented electrical steel sheet
22 Die
23 Guide
24 Punch
25 Conveyance direction
26 Pressurization direction

1. A wound core producing apparatus, the wound core being formed by bending and laminating a steel sheet, the wound core producing apparatus comprising:
a bending device that bends the steel sheet; and
a feed roll that feeds the steel sheet to the bending device,
wherein
the bending device includes a die and a punch for press working,
the punch is shifted in a conveyance direction of the steel sheet with respect to the die,
the die includes a curved portion disposed at an end portion on the punch side, and a flat portion continuously connected to the curved portion from a direction opposite to the punch side and in contact with the steel sheet, and
when a distance from a center of the feed roll to an end surface on the die side of the punch along the conveyance direction of the steel sheet is denoted by L mm, a diameter of the feed roll is denoted by R mm, a pressure applied to the steel sheet by the feed roll is denoted by p MPa, and a temperature at a position 20 mm away from a boundary between the curved portion and the flat portion in a direction opposite to the conveyance direction is denoted by T° C., the following formulas (1) and (2) are satisfied,
$$0.12 \leq ( L \times p ) / ( T \times R ) \leq 0 \text{.40} \qquad ( 1 )$$
$$0.4 \leq p \leq 2 \text{.00} . \qquad ( 2 )$$

2. The wound core producing apparatus according to claim 1, wherein a material of the feed roll is rubber, and
a Shore hardness of the rubber measured at 45° C. is A37 or less.

3. The wound core producing apparatus according to claim 2, wherein a material of the feed roll is urethane rubber.

4. A wound core producing method, comprising producing a wound core using the wound core producing apparatus according to claim 1.

5. A wound core producing method, comprising producing a wound core using the wound core producing apparatus according to claim 2.

6. A wound core producing method, comprising producing a wound core using the wound core producing apparatus according to claim 3.
